(19) United States
(12) Patent Application Publication
(10) Pub. No.: US 2006/0044505 A1
(43) Pub. Date: Mar. 2, 2006

(54) Electro-optical device and electronic apparatus

(76) Inventor: Masahiko Nakazawa, Hata (JP)

Correspondence Address: HARNESS, DICKEY & PIERCE, P.L.C., P.O. BOX 828, BLOOMFIELD HILLS, MI, 48303, US

(21) Appl. No.: 11/208,942

(22) Filed: Aug. 22, 2005

(30) Foreign Application Priority Data
Aug. 27, 2004 (JP) 2004-247917

(51) Int. Cl. G02F 1/1345

(52) U.S. Cl. 349/150

(57) ABSTRACT

An electro-optical device that displays an image on a display region on a substrate based on an input signal, includes a driving circuit element that has a plurality of electrode sections; a flexible printed board that has a plurality of first wiring lines; and an anisotropic conductive sheet that is formed to extend across the driving circuit element and the flexible printed board on the substrate and in which the plurality of electrode sections are electrically connected to a plurality of second wiring lines on the substrate, respectively, and the plurality of first wiring lines are electrically connected to the plurality of second wiring lines, respectively.

### BACKGROUND OF THE INVENTION

1. Technical Field

The present invention relates to electro-optical devices and to electronic apparatuses, and more specifically, to an electro-optical device having a driving circuit element mounted on a substrate and a flexible printed board connected to the substrate and to an electronic apparatus.

2. Related Art

Conventionally, electro-optical devices such as liquid crystal devices have been widely mounted on an electronic apparatus such as a cellular phone, a projector or the like.

A liquid crystal display panel having a two-dimensional-matrix-type liquid crystal display region is generally driven by a driving semiconductor device, such as a driver IC chip so as to generate an image by a transmitted light component and a reflected light component to display on the display region. The driver IC chip serving as a driving circuit element is mounted on the substrate of a liquid crystal panel by using an ACF (anisotropic conductive sheet) by a COG (Chip on Glass) method.

In that case, input signals such a power supply signal and an image signal are input from the outside through a flexible printed board (hereinafter, abbreviated to as a FPC) into the driver IC chip on the substrate of the liquid crystal display panel. The liquid crystal display panel is driven based on output signals including the power supply signal from the driver IC chip. The FPC to be connected to the substrate may be also connected by a different kind of ACF from the ACF for the driver IC chip (for example, see Japanese Unexamined Patent Application Publication No. 2003-223112).

FIGS. 4 and 5 are diagrams explaining a configuration example of the above liquid crystal display panel according to the related art. FIG. 4 is a plan view illustrating the liquid crystal display panel according to the related art. FIG. 5 is a partial cross-sectional view of the liquid crystal display panel taken along the line V-V of FIG. 4. As shown in FIG. 4, a liquid crystal display panel 101 has a display region 103 on a portion of a substrate 102. Input signals such as a power supply signal and a pixel signal for displaying an image on the display region 103 are supplied from an FPC 104.

The FPC 104 is electrically connected to wiring lines 102a and 102b on the substrate 102 by use of an ACF 105. On the substrate 102, driver IC chips 106, 107, and 108 are mounted by the COG method which uses an ACF 109. The input signals from the FPC 104 are supplied to the driver IC chips 106, 107, and 108 via the wiring lines 102a, and the output signals from the driver IC chips 106, 107, and 108 are supplied to the wiring lines of the display region 103 via the wiring lines 102b on the substrate 102.

However, according to a mounting method disclosed in Japanese Unexamined Patent Application Publication No. 2003-223112, during manufacturing the liquid crystal panel 101, two processes of forming the ACFs 105 and 109 for the driver IC chip and the FPC on the substrate 101 are needed.

In addition, two ACFs shown in Japanese Unexamined Patent Application Publication No. 2003-223112 partially overlap each other. However, two ACF regions are provided on the substrate 101 and thus the distance between the driver IC chip and the FPC is large. Therefore, the area of the substrate 102 where the driver IC chip and the FPC are mounted must be also large. When the distance between the driver IC chip and the FPC becomes large, there is a problem in that the wiring resistance on the substrate becomes large. Further, in a step S between the substrate 101 and the ACFs 105 and 109 shown in FIG. 4, or in a step between the ACFs (in the case of Japanese Unexamined Patent Application Publication No. 2003-223112), dust, water, or the like easily accumulates, which results in corrosion of the wiring lines on the substrate.

### SUMMARY

An advantage of the invention is that it provides an electro-optical device in which a driving circuit element and a FPC can be connected on a substrate by use of an ACF extending over a driver IC chip and the FPC.

According to an aspect of the invention, an electro-optical device that displays an image on a display region on the substrate based on input signals, includes a driving circuit element that has a plurality of electrode sections; a flexible printed board that has a plurality of first wiring lines; and an anisotropic conductive sheet that is formed to extend across the driving circuit element and the flexible printed board on the substrate and in which the plurality of electrode sections are electrically connected to a plurality of second wiring lines on the substrate, respectively, and the plurality of first wiring lines are electrically connected to the plurality of second wiring lines, respectively.

According to such a configuration, there can be provided the electro-optical device in which the driving circuit element and the FPC can be connected on the substrate by use of one ACF.

According to another aspect of the invention, it is preferable that an amount of projection of each of the plural first wiring lines projected from the surface of the flexible printed board which is in contact with the anisotropic conductive sheet be smaller than the thickness of the anisotropic conductive sheet.

According to such a configuration, the flexible printed board can be also reliably connected to the anisotropic conductive sheet.

According to a further aspect of the invention, it is preferable that the anisotropic conductive sheet be an anisotropic conductive sheet used for the COG method.

According to such a configuration, the electrical connection between the driving circuit element and the flexible printed board can be easily and reliably realized.

According to a still further aspect of the invention, an electro-optical device that displays an image on a display region on a substrate according to an input signal, includes a plurality of driving circuit elements of which each has a plurality of electrode sections; at least one flexible printed board that has a plurality of first wiring lines; and a plurality of anisotropic conductive sheets of which each is formed to extend across at least one of the plurality of driving circuit elements and at least one flexible printed board on the substrate, in which the plurality of electrode sections are electrically connected to a plurality of second wiring lines on the substrate, respectively, and the plurality of first wiring lines are electrically connected to the plurality of second wiring lines, respectively.

According to such a configuration, the plurality of driving circuit elements and the FPC can be connected on the substrate by use of the plurality of ACFs and further, the usage of ACF can be decreased.

According to a still further aspect of the invention, an electronic apparatus has the electro-optical device of the invention.

According to such a configuration, the electronic apparatus on which the electro-optical device is mounted can be downsized.

### BRIEF DESCRIPTION OF THE DRAWINGS

The invention will be described with reference to the accompanying drawings, wherein like numbers reference like elements, and wherein:

FIG. 1 is a plan view explaining a configuration of a liquid crystal display panel according to an embodiment of the invention;

FIG. 2 is a cross-sectional view of the liquid crystal display panel taken along the line II-II of FIG. 1;

FIG. 3 is a plan view illustrating a modification of the embodiment of the invention;

FIG. 4 is a plan view illustrating a liquid crystal display panel according to the related art; and

FIG. 5 is a partial cross-sectional view of the liquid crystal display panel taken along the line V-V of FIG. 4.

### DESCRIPTION OF THE EMBODIMENTS

Hereinafter, a liquid crystal display panel as an electro-optical device according to an embodiment of the invention will be described with reference to the drawings. The liquid crystal display panel according to the present embodiment may be a passive-type panel such as an STN or may be an active-type panel such as a TFD, a TFT, or an LTP.

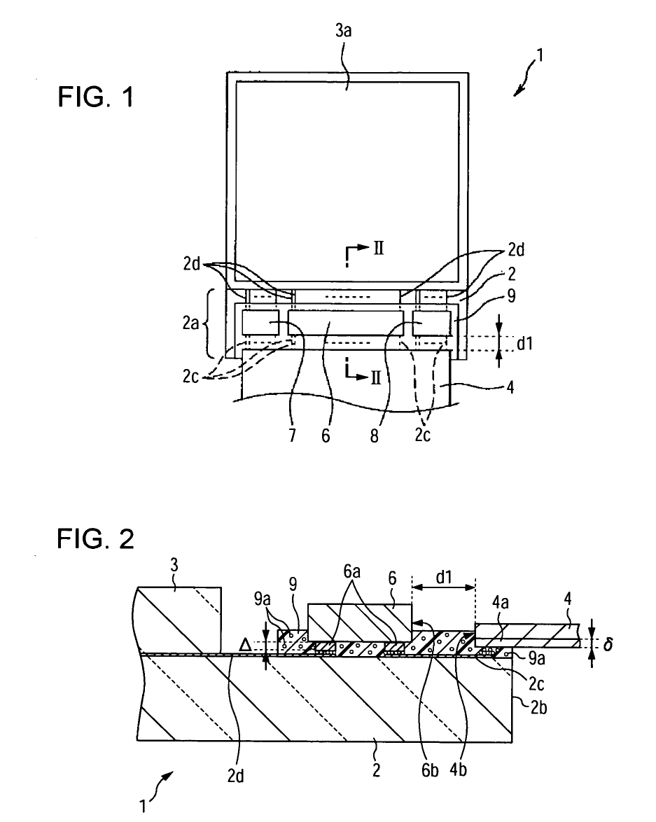

FIG. 1 is a plan view explaining a configuration of the liquid crystal panel according to an embodiment of the invention. FIG. 2 is a cross-sectional view of the liquid crystal panel taken along the line II-II of FIG. 1.

The liquid crystal panel 1 is constituted by bonding two glass substrates 2 and 3 to each other. Between the bonded two glass substrates, liquid crystal is sealed. A region where the liquid crystal is sealed constitutes a display region 3a as a display section, on which an image is displayed.

Between two substrates, one glass substrate 2 has a larger area than the other glass substrate 3. Therefore, in a state where two glass substrates 2 and 3 are bonded to each other, the substrate 2 has a portion 2a (hereinafter, referred to as an extending portion) which extends from the substrate 3. On the top surface of the extending portion 2a, a plurality of inputting and outputting wiring lines 2c and 2d are formed, respectively.

Into the liquid crystal display panel 1, input signals such as a power supply signal and an image signal for displaying an image on the display region 3a are supplied from a FPC 4. The supplied input signals are input to driver IC chips 6, 7, and 8 via the inputting wiring lines 2c formed on the substrate 2. The output signals from the driver IC chips 6, 7, and 8 are supplied to the wiring line of the display region 3a via the outputting wiring lines 2d formed on the substrate 2.

The plurality of inputting wiring lines 2c are formed in a substantially straight line parallel to each other on the substrate 2. Similarly, the plurality of outputting wiring lines 2d are also formed in a substantially straight line parallel to each other on the substrate 2. This makes it possible to suppress variation in wiring resistance and to make the extending portion 2a be small.

In addition, on a surface (hereinafter, referred to as a bottom surface) of the driver IC chip 6 which faces the substrate, a plurality of bumps 6a serving as electrode sections for input signals are provided in one line along the long side of the bottom surface. Similarly, a plurality of bumps 6a serving as electrode sections for output signals are provided in one line along another side opposite to the above-described long side.

Moreover, in FIG. 1, three driver IC chips 6, 7, and 8 are provided on the substrate 2, but this is because one driver IC chip 6 in the X direction of the two-dimensional matrix is combined with two driver IC chips 7 and 8 in the Y direction so that an image display is performed on the display region 3a. However, if one driver IC chip performs a process in both X and Y directions, only one driver IC chip is mounted on the substrate. In addition, if two driver IC chips perform processes in the X direction and in the Y direction, respectively, only two driver IC chips are mounted on the substrate.

The FPC 4 and the driver IC chips 6, 7, and 8 are electrically connected to the plurality of wiring lines 2c on the substrate 2 by use of an ACF 9 extending across the FPC 4 and the driver IC chips 6, 7, and 8. More specifically, the driver IC chips 6, 7, and 8 are mounted on the substrate 2 by the COG method that uses a portion of the region of the ACF 9. The FPC 4 is connected by using another portion of the region of the ACF 9 on the substrate 2.

In detail, the extending portion 2a has a substantially rectangular shape, as shown in a plan view of FIG. 1. Three driver IC chips 6, 7, and 8 having a substantially rectangular parallelepiped shape are disposed parallel to each other on the substantial center of the extending portion 2a. By pressing with a predetermined force, the driver IC chips 6, 7, and 8 are fixed to the surface of the ACF 9 by the COG method. The FPC 4 is also fixed to the substrate, by pressing the surface of the ACF 9 with a predetermined force and heat. Moreover, since the driver IC chips 7 and 8 have the same configuration as the driver IC chip 6, hereinafter, only the driver IC chip 6 will be described with reference to FIG. 2.

The ACF 9 having a substantially rectangular shape is provided on the surface of the substrate 2. One side thereof is formed to be parallel to one side of the substrate 3 and the other side opposite thereto is formed to be parallel to an end surface 2b of the substrate 2. In addition, the wiring direction of the plurality of wiring lines of the FPC 4 is orthogonal to the longitudinal direction of the ACF 9. The driver IC chip 6 and the FPC 4 are provided on the substrate 2 so that one surface 6b of the driver IC chip 6, which faces the end surface 4b of the FPC 4 parallel to the longitudinal direction of the ACF 9, is parallel to the end surface 4b of the FPC 4. This is because, when two surface 6b and 4b are parallel to each other, the distance between the driver IC chip 6 and the FPC 4 becomes the shortest.

The ACF 9 is made of a material for example, in which many conductive particles 9a are dispersed in a thermosetting resin. On the surface (hereinafter, referred to as a bottom surface) of the driver IC chip 6 which faces the substrate, the plurality of bumps 6a are provided as electrodes. If the state of the ACF 9 changes from a state where a non-cured ACF is adhered to the substrate 2 to a state where the ACF is pressed by a predetermined force and heat, the distance between the bump 6a on the bottom surface of the driver IC chip 6 and metallic wiring lines 2c and 2d on the substrate 2 becomes a predetermined distance. In the predetermined distance, since the distance between the conductive particles 9a is enough to turn on an electric current, an electrical signal can be transmitted between the respective bumps 6a and the wiring lines on the substrate 2. Therefore, the thickness of the ACF 9 to be adhered in a non-cured state is such a thickness that the bump 6a and the wiring line on the substrate 2 after pressure bonding are electrically connected to each other by the conductive particles 9a.

Further, in order to fix the driver IC chip 6 to the substrate 2, the ACF must be sufficiently filled between the bottom surface of the driver IC chip 6 and the substrate 2. For this reason, the thickness of the ACF 9 is related to an amount A of projection of the bump 6a projected from the surface of the packaging of the driver IC chip 6, in addition to the distance between the bump 6a and the wiring lines of the substrate 2 when pressed to be bonded. Therefore, the ACF 9 must be bonded so as to have a predetermined thickness or more, and the minimum thickness dmin of the ACF 9 has the relationship expressed by the following equation (1):
dmin=f(Δ) (1).

That is, the minimum thickness dmin of the ACF 9 is a function of an amount A of projection of the bump 6a, as shown in Equation (1).

However, by pressing the FPC 4, the metallic wiring line 4a of the FPC 4 is electrically connected to the wiring line on the substrate 2, an amount Δ of projection of the metallic wiring line 4a projected from the surface of the FPC 4 needs to be smaller than the above dmin. This is because, if the projection of the metallic wiring line 4a is not sufficiently covered by the ACF 9, it is likely that the metallic wiring line 4a of the FPC 4 is not reliably electrically connected to the wiring line 2c on the substrate 2 by the ACF 9. Accordingly, the minimum thickness dmin of the ACF 9 and an amount Δ of projection of the metallic wiring line 4a need to have the relationship expressed by the following equation (2):
Δ<dmin (2).

That is, an amount Δ of projection is smaller than the thickness of the ACF 9. As described above, on the liquid crystal display panel 1, the driver IC chips 6, 7, and 8 and the FPC 4 are mounted on the substrate 2 by use of only the ACF 9.

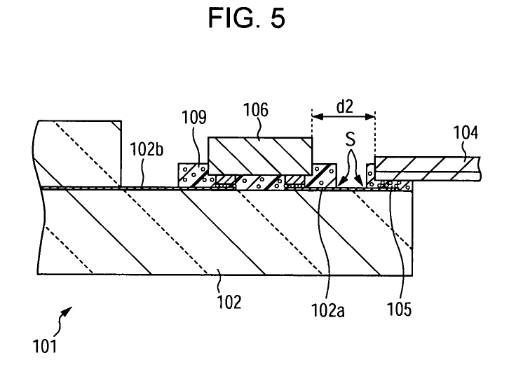

According to the above-described configuration, a distance d1 between the respective sides of the driver IC chip 6 and the FPC 4 facing each other can be made small. For example, in the case of the liquid crystal panel 101 according to the related art shown in FIG. 5, a distance d2 between the respective sides of the driver IC chip 106 and the FPC 104 facing each other is set to 0.5 mm, for example, in consideration of an adhesion deviation, width tolerance of the ACF, and mounting tolerance between the driver IC chip 6 and the FPC 4. On the contrary, although there exist various design limitations in the case of the liquid crystal display panel 1 according to the present embodiment, the distance d1 between the respective sides of the driver IC chip 6 and the FPC 4 facing each other can be set to 0.2 mm, for example. Further, only the mounting tolerance between the driver IC chip 6 and the FPC 4 may be considered. Accordingly, the size of the liquid crystal display panel 1 can be made small. In addition, since the distance d1 between the respective sides of the driver IC chip 6 and the FPC 4 facing each other, the wiring resistance can be reduced.

Further, since only one ACF 9 is provided on the substrate 2, wiring corrosion caused by dust accumulated on the step section between two ACFs does not occur, as shown in the related art.

Furthermore, an electronic apparatus such as a cellular phone on which the liquid crystal panel 1 is mounted can be downsized.

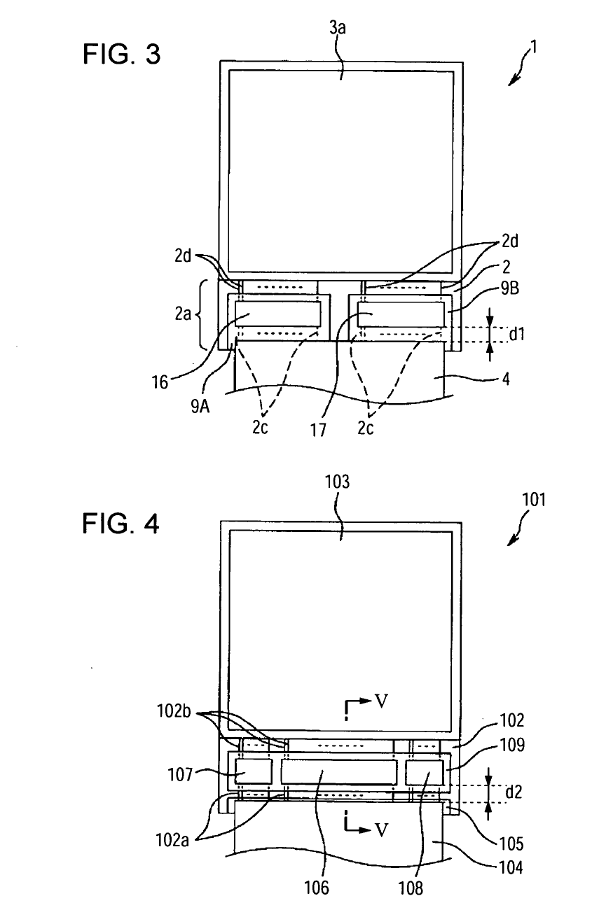

Moreover, as a modification of the present embodiment, the region of the AFC between a plurality of driver IC chips may be not provided, when there are a plurality of driver IC chips. FIG. 3 is a plan view illustrating a modification when the plurality of driver IC chips are mounted by use of a plurality of ACFs.

As shown in FIG. 3, in the liquid crystal display panel 1, two driver IC chips 16 and 17 are mounted on the extending portion 2a through the COG method by use of the respective ACFs 9A and 9B. Then, the FPC 4 is connected to two ACFs 9A and 9B on the extending portion 2a. In this case, as shown in FIG. 1, only one ACF 9 may be provided. However, when two ACFs 9A and 9B are used, the usage of ACF can be decreased. The ACF 9A extending across the FPC 4 and the driver IC chip 16 and the ACF 9B extending across the FPC 4 and the driver IC chip 17 are used.

Even in the above modification, a distance d1 between the respective sides of the driver IC chip 16 or 17 and the FPC 4 facing each other can be made small, similarly to the configuration shown in FIG. 1.

In addition, in the related art, an ACF for driver IC chip and an ACF for FPC are independently used, and one kind of ACF is not used in common to the driver IC chip and the FPC. Therefore, when one kind of ACF is used in common, it is not clear what conditions are required. According to the present embodiment, the amount of projection of each of the plural bumps of the driver IC chip is made larger than the amount of projection of each of the wiring lines from the surface of the FPC, as shown in Equations (1) and (2). Therefore, with one kind of ACF is used in common to the driver IC chip and the FPC, the driver IC chip and the FPC can be reliably electrically connected to each other.

As described above, according to the present embodiment and the modification thereof, the distance d1 between the respective sides of the driver IC chip 6 and the FPC 4 facing each other can be made small. Further, wiring corrosion on the substrate between the ACF for driver IC chip and the ACF for FPC does not occur, which is caused by using a plurality of ACFs as in the related art.

This invention is not limited to the above-described embodiment, but various modifications can be made within the scope without departing from the spirit of this invention.

This invention can be also similarly applied to various electro-optical devices such as an electroluminescent device, an organic electroluminescent device, a plasma display device, an electrophoretic display device, a device using an electron emission elements (Field Emission Display, Surface-Conduction Electron-Emission Display or the like), and the like, other than a liquid crystal display panel.

As an electronic apparatus to which the electro-optical device according to this invention can be applied, there are provided a PDA (Personal Digital Assistance), a portable personal computer, a digital camera, an on-vehicle monitor, a digital video camera, a liquid crystal TV, a viewfinder-type or monitor-direct-view-type video tape recorder, a car navigation device, a pager, an electronic organizer, an electronic calculator, a word processor, a workstation, a video phone, a POS terminal, in addition to a cellular phone and a projector.

What is claimed is:

1. An electro-optical device, comprising:
a driving circuit element that has a plurality of electrode sections;
a flexible printed board that has surface formed with a plurality of first wiring lines;
a substrate formed with a plurality of second wiring lines; and
an anisotropic conductive sheet that is formed to extend across the driving circuit element and the flexible printed board on the substrate and in which the plurality of electrode sections are electrically connected to a plurality of second wiring lines on the substrate, respectively, and the plurality of first wiring lines are electrically connected to the plurality of second wiring lines, respectively,
wherein the surface formed with the plurality of first wiring lines contacts the anisotropic conductive sheet, the plural first wiring lines projecting from the surface of the flexible printed board by an amount that is smaller than the thickness of the anisotropic conductive sheet.

2. The electro-optical device according to claim 1,
wherein the driving circuit element has a substantially rectangular parallelepiped shape, and one surface of the rectangular parallelepiped facing the end surface of the flexible printed board orthogonal to the wiring direction of the plurality of first wiring lines is parallel to the end surface.

3. The electro-optical device according to claim 1,
wherein the anisotropic conductive sheet is an anisotropic conductive sheet used for the COG method.

4. An electro-optical device that displays an image on a display region on a substrate based on an input signal, comprising:
a plurality of driving circuit elements of which each has a plurality of electrode sections;
at least one flexible printed board that has a plurality of first wiring lines; and
a plurality of anisotropic conductive sheets of which each is formed to extend across at least one of the plurality of driving circuit elements and at least one flexible printed board on the substrate, on which the plurality of electrode sections are electrically connected to a plurality of second wiring lines on the substrate, respectively, and the plurality of first wiring lines are electrically connected to the plurality of second wiring lines, respectively,
wherein an amount of projection of each of the plural first wiring lines from the surface of at least one flexible printed board which is in contact with the plurality of anisotropic conductive sheets is smaller than the thickness of each of the plural anisotropic conductive sheets.

5. An electronic apparatus comprising the electro-optical device according to claim 1.
